(19) United States
(12) Patent Application Publication
(10) Pub. No.: US 2021/0352926 A1
(43) Pub. Date: Nov. 18, 2021

(54) Methods for Reduced Oil Migration

(71) Applicant: Utah State University, Logan, UT (US)

(72) Inventor: Silvana Martini, North Logan, UT (US)

(21) Appl. No.: 17/385,726

(22) Filed: Jul. 26, 2021

Related U.S. Application Data
(62) Division of application No. 15/970,752, filed on May 3, 2018.
(60) Provisional application No. 62/500,885, filed on May 3, 2017.

(51) Int. Cl. A23D 7/04; A23D 7/00

(52) U.S. Cl. CPC A23D 7/04; A23D 7/001

(57) ABSTRACT

The disclosure generally provides for lipid compositions, foodstuffs, and methods for reducing lipid migration in a food product, the methods comprise sonicating a low saturated lipid with a high intensity ultrasound, and incorporating the sonicated low saturated lipid to a food composition.

This application is a divisional of U.S. application Ser. No. 15/970,752 filed on May 3, 2018, which claims priority to U.S. Provisional Patent Application No. 62/500,885 filed on May 3, 2017, all of which are incorporated by reference herein in their entirety.

### CROSS REFERENCE TO RELATED APPLICATIONS

This invention was made with government support under contract number IIP1318194 awarded by the National Science Foundation and under contract number DE-EE0006857 awarded by the Department of Energy. The government has certain rights in the invention.

### TECHNICAL FIELD

Described herein are compositions and methods for reducing lipid migration in low saturated fats using high intensity ultrasound. In particular, food compositions comprising sonicated low saturated fats are described.

### BACKGROUND

Lipids impact the quality of high-fat foods by providing flavor, flavor stability, physical characteristics, and crystal habit. Lipids used by the food industry a classified based on physical properties into liquid oils, shortenings, margarines, and spreads. Liquid oils are used as cooking oils for pan and deep-fat frying or as salad oils. Shortenings are used in processed foods, while margarines and spreads are used as table fat, cooking fat, or baking fat. Shortening can be classified as baking, frying, or dairy analog shortenings.

Shortenings used in baking applications are designed with specific physical properties for a range of applications. An all-purpose shortening having a wide plastic range, where the shortening texture does not change over a wide range of temperatures, is used to manufacture products such as soft cookies, Danish pastries, and puff pastry dough. On the other hand, all-purpose shortenings having a narrow plastic range are suited for formulations such as hard cookies, cookie fillers, and chips. Some all-purpose shortenings contain emulsifiers such as mono- and diglycerides, lecithin, polyglycerol, or polysorbate that promote air incorporation and control viscosity in products such as cakes, icings, and fillings. Frying shortenings are usually characterized by fast melting over a narrow melting range, providing frying stability and palatability. Dairy analog shortenings require a wide range of physical properties tailored to specific applications. For example, shortenings used for liquid coffee whiteners are characterized by low melting points and steep melting curves, while shortenings used in spray-dried coffee creamers are characterized by higher melting points, allowing for a free flow of the fine powder These examples confirm the relevance of controlling the physical characteristics of lipids to obtain high-quality food products.

Shortenings can be characterized by the following physical properties: crystal size, melting behavior, amount of solids, crystal habit, and texture. These properties are related to the type of crystalline network formed in the lipid material during processing. In general, shortening manufacture involves heating the lipid to a temperature above its melting point and then cooling to induce crystallization. The crystalline network formed during cooling defines the physical properties of the material. For example, a hard and brittle material is obtained in a crystalline network having a high amount of solids. Physical properties of lipid networks can be tailored to some degree by manipulating processing conditions such as cooling rate, crystallization, and storage temperature, the use of emulsifiers or additives, and the use of agitation or shear. For example, softer crystalline networks can be obtained by increasing agitation or by using specific emulsifiers.

Oil migration, or phase separations, in food products containing fats can reduce the shelf life and quality of food products. Fat bloom and textural changes (harder filling and softer coating) are common problems in confectionary food products. Various solutions have been proposed to control oil migration in food products, including reduction in chocolate particle size, minimization of oil content in fillings, use of harder fats in fillings, and the addition of start to fillings. There remains a need for lipids that comprise properties that mitigate the problem of oil migration, and phase separation in food products.

### SUMMARY

In one aspect, a food composition, comprising a food stuff and a lipid composition is described. The lipid composition comprises from about 20% to about 35% of a low saturated lipid selected from the group consisting of one or more of mono-, di-, or tri-fatty acid esters of glycerol; wherein the low saturated lipid is sonicated with a high intensity ultrasound. The food composition is in the form of a spread, a confectionery, a confectionery filling, a shortening, a dessert, a chocolate, a salad dressing, or a mayonnaise type product. In one aspect, the lipid composition does not migrate through the foodstuff as quickly as a lipid composition in which the low saturated lipid has not undergone sonication.

In another aspect, a food composition with reduced lipid migration suitable for human consumption is described. The food composition includes a low saturated lipid at a concentration from about 2% to about 99% by weight, a water content of from about 1% to about 98% by weight, and optionally an antioxidant from about 0.01% to about 1% by weight. The low saturated lipid is selected from the group consisting of one or more of mono-, di-, or tri-substituted fatty acid esters of glycerol; and wherein the low saturated lipid is sonicated using a high intensity ultrasound. The low saturated lipid does not migrate through the foodstuff as quickly as a low saturated lipid that has not undergone sonication. In one aspect, the food composition is in the form of a spread. In another aspect, the food composition is suitable for use in baking or is suitable for use in desserts.

In an aspect, a method for reducing lipid migration of a lipid composition in a foodstuff is described. The method includes sonicating a low saturated lipid with a high intensity ultrasound, wherein the low saturated lipid is selected from the group consisting of one or more of mono-, di-, or tri-fatty acid esters of glycerol, and adding the sonicated low saturated lipid to a foodstuff. In an aspect of the method, the low saturated lipid is in a lipid mixture where the low saturated lipid is from 20% to about 35% by weight of the lipid mixture. In yet another aspect, the low saturated lipid is selected from palm oil, soybean oil, coconut oil, vegetable oil, cocoa butter, cocoa lipid, anhydrous milk fat, lard, tallow, and mixtures thereof. In an aspect of the method, the high intensity ultrasound has a frequency of about 15 kHz to about 100 kHz. In yet another aspect, the method the high intensity ultrasound has a frequency of about 18 kHz to about 22 kHz. In another aspect of the method, the duration of high intensity ultrasound is between about 1 second and about 10 seconds. In another aspect of the method, the intensity of high intensity ultrasound is between about 3 Watts and about 100 Watts. The duration, intensity, and frequency of the ultrasound are configured so that the lipid does not exceed its melting point. In an aspect of the method, the high intensity ultrasound is applied at the onset of crystallization, whereas, in another aspect, the high intensity ultrasound is applied before crystallization. In an aspect of the method, the high intensity ultrasound is applied to a lipid composition comprising the low saturated lipid which crystallizes under static conditions. In another aspect of the method, the high intensity ultrasound is applied to a lipid that crystallizes under agitated conditions, wherein the agitation is between about 5 rpm and about 200 rpm.

### BRIEF DESCRIPTION OF THE DRAWINGS

FIG. 1 shows a schematic of oil migration measurement method used in embodiments disclosed herein.

FIG. 2 shows a graphical representation of oil migration observed in IESBO (32% saturation), with and without high intensity ultra-sonication treatment.

FIG. 3 shows polarized light micrographs depicting crystal morphology obtained for IESBO crystallized for 90 minutes at different crystallization temperatures, with and without high intensity ultra-sonication treatment.

FIG. 4 shows a graphical representation of oil migration data obtained for Palm Kernel oil-based fat (“PK73”) and Palm oil based-fat samples (“P49”), with and without high intensity ultra-sonication treatment.

FIG. 5 shows plane polarized micrographs depicting crystal morphology obtained for PK73 and P49 crystallized for 90 minutes at different crystallization temperatures, with and without high intensity ultra-sonication treatment.

### DETAILED DESCRIPTION

The present disclosure covers apparatuses and associated methods for reducing oil migration. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

### Definitions

The terms used in this specification generally have their ordinary meanings in the art. Unless defined otherwise below, all technical and scientific terms used herein have the meaning commonly understood by a person skilled in the art. Certain terms are discussed below, or elsewhere in the specification, to provide additional guidance to the practitioner in describing the compositions set forth herein.

The term “high frequency ultrasound” as used herein refers to sinusoidal sound waves that travel through a material at frequencies above the upper limit of human detection, using frequencies between 20 kHz and 1 MHz. In this specification and the claims that follow, singular forms such as “a,” “an,” and “the” include plural forms unless the content clearly dictates otherwise. Also, as used herein, “and/or” refers to and encompasses any and all possible combinations of one or more of the associated listed items, as well as the lack of combinations when interpreted in the alternative (“or”).

All ranges disclosed herein include, unless specifically indicated, all endpoints and intermediate values. In addition, “optional” or “optionally” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

The terms “lipid,” “fat” and “oil” as used herein are interchangeable and refer to any of a class of molecules that are soluble in nonpolar solvents (such as ether and hexane) and relatively or completely insoluble in water. The terms lipid, fat, and oil, as used herein refer to one or more of, mono-, di-, or tri-fatty acid esters of glycerol.

In embodiments described herein, the methods and compositions outlined herein may use any fat low in saturated fatty acids, or “low saturated lipid.” Exemplary low saturated lipids include edible fats with saturation percentages of from about 0% to about 48%, from about 20% to about 35%, or about 32%. Exemplary fat sources that may be used with the methods described herein include vegetable and animal fat sources, including, for example, fats sourced from palm oil, soybean oil, coconut oil, cocoa lipid, cocoa butter, butter, anhydrous milk fat, lard, tallow, and combinations thereof. Mixtures of fats may also be used. In some embodiments, inter-esterified soybean oil with a saturation of about 32% may be used. In particular, fats used in confectionary and food products where the fat is prone to oil migration may be used in the methods set forth herein.

In the embodiments described herein, the term “waxes” is defined as esters of long alkyl chains and long chain alcohols. Waxes as defined herein may be synthetic or of natural origin. Waxes may also include various functional groups such as fatty acids, primary and secondary long chain alcohols, unsaturated bonds, aromatics, amides, ketones, and aldehydes.

The term “substantially” as used herein means to a great or significant extent, but not completely.

As used herein, all percentages (%) refer to weight (mass) percent unless noted otherwise.

The term “about” as used herein refers to any values, including both integers and fractional components that are within a variation of up to ±10% of the value modified by the term “about.”

The terms such as “include,” “including,” “contain,” “containing,” “has,” or “having,” and the like, as used herein are interchangeable and mean “comprising.”

The term “or” as used herein may be conjunctive or disjunctive.

The present disclosure covers methods, compositions, reagents, and kits for the reduction of oil migration in low-saturated fats using high intensity ultrasound.

The term “salad dressing” as used herein means a salad dressing that is a stable dispersion or emulsion with high viscosity and a slow pour-rate that may be considered pourable or spoonable. Generally, salad dressings are opaque, but they may also be clear or translucent.

The terms “food”, “food composition,” “food product,” and “foodstuff” as used herein are interchangeable and refer to mean any composition intended to be or expected to be ingested by humans.

High-intensity ultrasound (“HIU”), also known as power ultrasound, is used to induce crystallization of organic and inorganic compounds. Food scientists have recently extended the use of sonocrystallization to food components such as ice, sucrose, and lipids This technology has potential use on an industrial scale to improve the physical properties of lipids with low level of saturated fatty acids and trans-fatty acids free lipids.

In embodiments described herein, the use of ultrasound at a frequency, intensity, and duration is configured for the particular fat being sonicated. Sonication at a frequency, intensity, and duration that results in the fat melting is typically undesirable. Sonication is configured so that the temperature of the fat does not exceed the melting point of the fat, such as about 5 degrees Centigrade below the melting point of the fat. Exemplary frequencies to be used in the methods set forth herein include from about 15 kHz to about 100 kHz, or from about 18 kHz to about 22 kHz, or about 20 kHz. Exemplary duration of sonication in some embodiments of the methods may be from about 2 seconds to about 60 seconds, from about 2 seconds to about 15 seconds, or about 10 seconds. Exemplary intensity of the high intensity ultrasound in some embodiments is between about 3 Watts and about 200 Watts.

In one embodiment, the ultrasound is applied in a lipid such that the lipid crystallizes under agitation. Exemplary agitation conditions to be used in the methods set forth herein include from about 5 rpm to about 20,000 rpm, or about 5 rpm to about 10,000 rpm, or about 5 rpm to about 5,000 rpm, or about 5 rpm to about 1,000 rpm, or about 5 rpm to about 900 rpm, or about 5 rpm to about 800 rpm, or about 5 rpm to about 700 rpm, or about 5 rpm to about 600 rpm, or about 5 rpm to about 500 rpm, or about 5 rpm to about 400 rpm, or about 5 rpm to about 300 rpm, or about 5 rpm to about 200 rpm, or about 5 rpm to about 190 rpm, from about 5 rpm to about 180 rpm, or from about 5 rpm to about 170 rpm, or about 5 rpm to about 160 rpm, or about 5 rpm to about 150 rpm, or about 5 rpm to about 140 rpm, or about 5 rpm to about 130 rpm, or about 5 rpm to about 120 rpm, or about 5 rpm to about 110 rpm, or about 5 rpm to about 100 rpm, or about 5 rpm to about 90 rpm, or about 5 rpm to about 80 rpm, or about 5 rpm to about 70 rpm, or about 5 rpm to about 60 rpm, or about 5 rpm to about 50 rpm.

In another embodiment, the ultrasound is applied in a lipid such that the lipid crystallizes under static conditions.

Oil or lipid migration, or phase separations, in food products containing fats can reduce the shelf life and quality of food products. Fat bloom and textural changes (harder filling and softer coating) are common problems in confectionary food products. Various solutions have been proposed to control oil migration in food products, including reduction in chocolate particle size, minimization of oil content in fillings, use of harder fats in fillings, and the addition of start to fillings. The methods described herein overcome the above issues by reducing oil migration with sonication as described herein.

In one embodiment, the method for preparing crystals in a low saturated lipid described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell constant using an external water bath and keeping the agitation at 100 rpm; (d) stopping the agitation after about 10 minutes; (e) allowing crystallization in the lipid sample under static conditions for about 90 minutes; and (f) cooling the lipid sample to about 5° C. for about 48 hours.

In embodiments described herein, lipid samples were crystallized without and with the application of HIU.

In some embodiments described herein, lipid samples were crystallized without the application of HIU under static conditions.

In another embodiment, the method for preparing crystals in an interesterified soybean oil (“IESBO”) described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 26° C. using an external water bath and keeping the agitation at 100 rpm; (d) stopping the agitation after about 10 minutes; (e) allowing crystallization in the lipid sample under static conditions for about 90 minutes; and (f) cooling the lipid sample to about 5° C. for about 48 hours.

In another embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 28° C. using an external water bath and keeping the agitation at 100 rpm; (d) stopping the agitation after about 10 minutes; (e) allowing crystallization in the lipid sample under static conditions for about 90 minutes; and (f) cooling lipid sample to about 5° C. for about 48 hours.

In another embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 30° C. using an external water bath and keeping the agitation at 100 rpm; (d) stopping the agitation after about 10 minutes; (e) allowing crystallization in the lipid sample under static conditions for about 90 minutes; and (f) cooling the lipid sample to about 5° C. for about 48 hours.

In another embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 32° C. using an external water bath and keeping the agitation at 100 rpm; (d) stopping the agitation after about 10 minutes; (e) allowing crystallization in the lipid sample under static conditions for about 90 minutes; and (f) cooling lipid sample to about 5° C. for about 48 hours.

In another embodiment, the method for preparing crystals in PK73 described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 30° C. using an external water bath and keeping the agitation at 100 rpm; (d) stopping the agitation after about 10 minutes; (e) allowing crystallization in the lipid sample under static conditions for about 90 minutes; and (f) cooling the lipid sample to about 5° C. for about 2 hours.

In another embodiment, the method for preparing crystals in P49 described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 25° C. using an external water bath and keeping the agitation at 100 rpm; (d) stopping the agitation after about 10 minutes; (e) allowing crystallization in the lipid sample under static conditions for about 90 minutes; and (f) cooling lipid sample to about 5° C. for about 48 hours.

In some embodiments described herein, lipid samples were crystallized with the application of high intensity ultrasound (HIU) under static conditions.

In one embodiment, the method for preparing crystals in a low saturated lipid described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell constant using an external water bath and keeping the agitation at 100 rpm; (d) stopping the agitation after about 10 minutes; (e) applying high intensity ultrasound at the onset of crystallization, using a 3.2 mm diameter tip operating at an amplitude of 216 μm for 10 seconds; (f) allowing crystallization to continue in the lipid sample under static conditions for about 90 minutes; and (g) cooling lipid sample to about 5° C. for about 48 hours.

In one embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell constant at 26° C. using an external water bath and keeping the agitation at 100 rpm; (d) stopping the agitation after about 10 minutes; (e) applying high intensity ultrasound at the onset of crystallization using a 3.2 mm diameter tip operating at an amplitude of 216 μm for 10 seconds; (f) allowing crystallization to continue in the lipid sample under static conditions for about 90 minutes; and (g) cooling the lipid sample to about 5° C. for about 48 hours.

In one embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell constant at 28° C. using an external water bath and keeping the agitation at 100 rpm; (d) stopping the agitation after about 12 minutes; (e) applying high intensity ultrasound at the onset of crystallization using a 3.2 mm diameter tip operating at an amplitude of 216 μm for 10 seconds; (f) allowing crystallization to continue in the lipid sample under static conditions for about 90 minutes; and (g) cooling the lipid sample to about 5° C. for about 48 hours.

In one embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell constant at 30° C. using an external water bath and keeping the agitation at 100 rpm; (d) stopping the agitation after about 13 minutes; (e) applying high intensity ultrasound at the onset of crystallization using a 3.2 mm diameter tip operating at an amplitude of 216 μm for 10 seconds; (f) allowing crystallization to continue in the lipid sample under static conditions for 90 minutes; and (g) cooling the lipid sample to about 5° C. for about 48 hours.

In one embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell constant at 32° C. using an external water bath and keeping the agitation at 100 rpm; (d) stopping the agitation after about 16 minutes; (e) applying high intensity ultrasound at the onset of crystallization using a 3.2 mm diameter tip operating at an amplitude of 216 μm for 10 seconds; (f) allowing crystallization to continue in the lipid sample under static conditions for 90 minutes; and (g) cooling the lipid sample to about 5° C. for about 48 hours.

In another embodiment, the method for preparing crystals in PK73 described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 30° C. using an external water bath and keeping the agitation at 100 rpm; (d) stopping the agitation after about 20 minutes; (e) applying high intensity ultrasound at the onset of crystallization using a 3.2 mm diameter tip operating at an amplitude of 216 μm for 10 seconds; (f) allowing crystallization in the lipid sample under static conditions for about 90 minutes; and (g) cooling lipid sample to about 5° C. for about 2 hours.

In another embodiment, the method for preparing crystals in P49 described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 30° C. using an external water bath and keeping the agitation at 100 rpm; (d) stopping the agitation after about 30 minutes; (e) applying high intensity ultrasound at the onset of crystallization using a 3.2 mm diameter tip operating at an amplitude of 216 μm for 10 seconds; (f) allowing crystallization in the lipid sample under static conditions for about 90 minutes; and (g) cooling the lipid sample to about 5° C. for about 2 hours.

In some embodiments described herein, lipid samples were crystallized with and without the application of HIU under agitation conditions.

In some embodiments described herein, lipid samples were crystallized without the application of HIU under agitation conditions.

In another embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 26° C. using an external water bath and keeping the agitation at 100 rpm; d) allowing crystallization in the lipid sample under agitation conditions for 90 minutes; and (e) cooling lipid sample to about 5° C. for about 48 hours.

In another embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 28° C. using an external water bath and keeping the agitation at 100 rpm; (d) allowing crystallization in the lipid sample under agitation conditions for about 90 minutes; and (e) cooling lipid sample to about 5° C. for about 48 hours.

In another embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 30° C. using an external water bath and keeping the agitation at 100 rpm; (d) allowing crystallization in the lipid sample under agitation conditions for about 90 minutes; and (e) cooling lipid sample to about 5° C. for about 48 hours.

In another embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 32° C. using an external water bath and keeping the agitation at 100 rpm; (d) allowing crystallization in the lipid sample under agitation conditions for about 90 minutes; and (e) cooling lipid sample to about 5° C. for about 48 hours.

In another embodiment, the method for preparing crystals in PK73 described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 30° C. using an external water bath and keeping the agitation at 100 rpm; (d) allowing crystallization in the lipid sample under agitation conditions for about 90 minutes; and (e) cooling lipid sample to about 5° C. for about 2 hours.

In another embodiment, the method for preparing crystals in P49 described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 25° C. using an external water bath and keeping the agitation at 100 rpm; (d) allowing crystallization in the lipid sample under agitation conditions for about 90 minutes; and (e) cooling lipid sample to about 5° C. for about 48 hours.

In some embodiments described herein, lipid samples were crystallized with the application of high intensity ultrasound (HIU) under agitation conditions.

In one embodiment, the method for preparing crystals in a low saturated lipid described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell constant using an external water bath and keeping the agitation at 100 rpm; (d) applying high intensity ultrasound at the onset of crystallization, using a 3.2 mm diameter tip operating at an amplitude of 216 μm for 10 seconds; (e) allowing crystallization to continue in the lipid sample under agitation conditions for about 90 minutes; and (f) cooling lipid sample to about 5° C. for about 48 hours.

In one embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell constant at 26° C. using an external water bath and keeping the agitation at 100 rpm; (d) applying high intensity ultrasound at the onset of crystallization, at about 10 minutes, using a 3.2 mm diameter tip operating at an amplitude of 216 μm for 10 seconds; (e) allowing crystallization to continue in the lipid sample under agitation conditions for about 90 minutes; and (f) cooling lipid sample to about 5° C. for about 48 hours.

In one embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell constant at 28° C. using an external water bath and keeping the agitation at 100 rpm; (d) applying high intensity ultrasound at the onset of crystallization, at about 12 minutes, using a 3.2 mm diameter tip operating at an amplitude of 216 μm for 10 seconds; (e) allowing crystallization to continue in the lipid sample under agitation conditions for about 90 minutes; and (f) cooling the lipid sample to about 5° C. for about 48 hours.

In one embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell constant at 30° C. using an external water bath and keeping the agitation at 100 rpm; (d) applying high intensity ultrasound at the onset of crystallization, at about 13 minutes, using a 3.2 mm diameter tip operating at an amplitude of 216 μm for 10 seconds; (e) allowing crystallization to continue in the lipid sample under agitation conditions for about 90 minutes; and (f) cooling the lipid sample to about 5° C. for about 48 hours.

In one embodiment, the method for preparing crystals in an IESBO described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell constant at 32° C. using an external water bath and keeping the agitation at 100 rpm; (d) applying high intensity ultrasound at the onset of crystallization, at about 16 minutes, using a 3.2 mm diameter tip operating at an amplitude of 216 μm for 10 seconds; (e) allowing crystallization to continue in the lipid sample under agitation conditions for 90 minutes; and (f) cooling the lipid sample to about 5° C. for about 48 hours.

In another embodiment, the method for preparing crystals in PK73 described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 30° C. using an external water bath and keeping the agitation at 100 rpm; (d) stopping the agitation after about 20 minutes; (e) allowing crystallization in the lipid sample under agitation conditions for 90 minutes; and (f) cooling the lipid sample to about 5° C. for about 2 hours.

In another embodiment, the method for preparing crystals in P49 described herein comprises: (a) placing a lipid sample in a microwave oven and heating until all the crystals are visibly melted; (b) transferring the lipid sample to an oven at 70° C. and keeping the lipid sample at this temperature for about 30 minutes to erase crystal memory; (c) transferring lipid sample to a double-walled crystallization cell (7 cm diameter and 11.5 cm height) equipped with a magnetic stirrer (7 mm width and 3 cm long) for agitating the lipid sample while keeping the temperature in the cell at 30° C. using an external water bath and keeping the agitation at 100 rpm; (d) stopping the agitation after about 30 minutes; (e) allowing crystallization in the lipid sample under agitation conditions for about 90 minutes; and (f) cooling the lipid sample to about 5° C. for about 2 hours.

In the embodiments described herein, high intensity ultrasound was applied at the onset of crystallization using a 3.2 mm diameter tip operating at an amplitude of 216 μm for 10 seconds. Without being bound by any theory, lower tip amplitudes (power levels) and longer exposure times were less effective.

In one embodiment, the method for testing oil migration described herein comprises: (a) placing crystallized lipid in a plastic tube with a diameter of about 1 cm; (b) tempering lipid sample at 5° C. for about 48 h for the IESBO and P49 lipid samples, at 5° C. for about 2 h for PK73 lipid sample; (c) cutting a 0.5 inch tall cylinder from the plastic tube containing the crystallized lipid for measuring oil migration; (d) placing the cylinder vertically on a filter paper (Whatman #1) at about at 5° C. for IESBO samples, or at 25° C. for PK73 lipid sample, or at 18° C. for P49 lipid sample; and (e) measuring the diameter of oil migration from the cylinder to the filter paper after 24 h of storage as shown in FIG. 1.

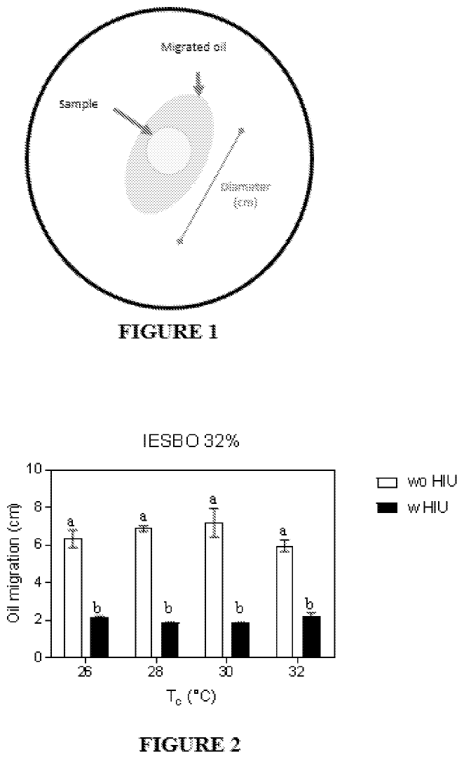

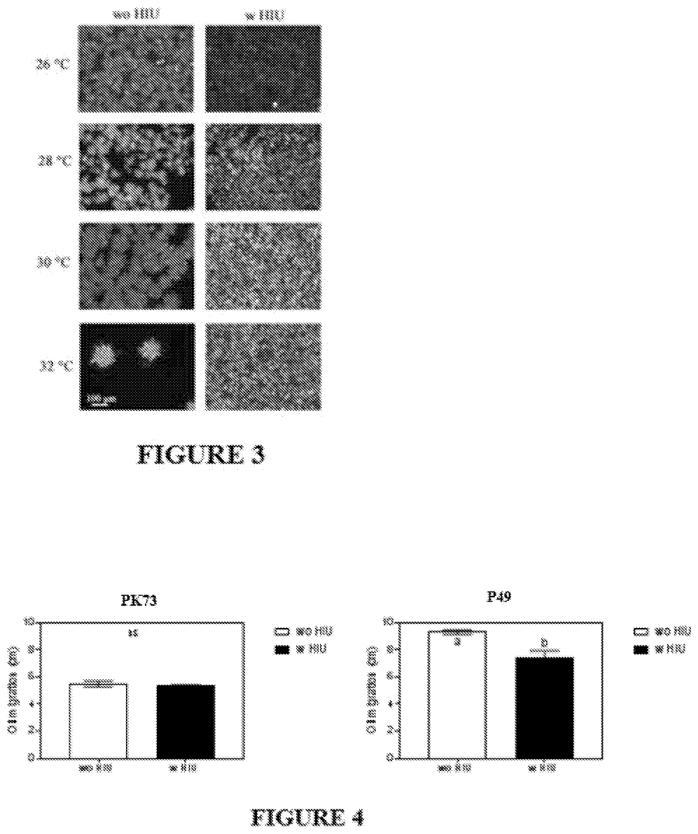

FIG. 2 shows the oil migration of an interesterified soybean oil with 32% of low saturated fats crystallized with high intensity ultrasound (“w HIU”) and without high intensity ultrasound (“wo HIU”). As shown in FIG. 2, more oil migrated in the wo HIU samples compared to w HIU samples. Without being bound by any theory, this decrease in oil migration may be due to the generation of smaller crystals during sonication as shown in FIG. 3. FIG. 3 shows images of crystal morphology (white structures) obtained for IESBO samples crystallized without and with HIU at different temperatures, as visualized by polarized light microscopy. As shown in FIG. 3, smaller crystals are generated for IESBO samples crystallized at 28° C., 30° C., and 32° C., while the reduction in crystal size is not significant for IESBO sample incubated at 26° C. FIG. 2 shows a corresponding decrease in oil migration in these samples. However, for the IESBO sample crystallized at 26° C., other factors may play a role in the reduction of oil migration as the decrease in crystal size is not as significant as shown in FIG. 3, while a reduction in oil migration is still observed as shown in FIG. 2. Without being bound by any theory, this result suggests that other factors such as the strength of the crystalline network formed may play a role in the reduction of oil migration.

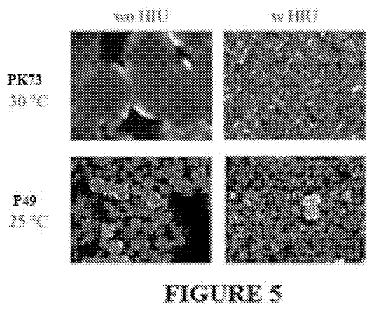

Similar oil migration experiments were performed for other types of samples: PK73 and P49. These two samples have higher levels of saturation (73% and 49%, respectively) compared to the 32% content of saturated fatty acids in the IESBO. Oil migration results for PK73 and P49 are shown in FIG. 4 and the crystal morphology is shown in FIG. 5.

FIG. 4 shows a decrease in oil migration for the P49 sample when ultrasound is used but no decrease is observed in the PK73 sample. Without being bound by any theory, it is likely that the high level of saturation hinders that effectiveness of sonication in decreasing oil migration. FIG. 5 shows a reduction in crystal size in both PK73 and P49 samples. FIG. 5 shows no significant decrease in crystal size for P49 incubated at a low temperature (25° C.). Without being bound by any theory, the result suggests that the microstructure or crystal size is not the only factor that drives ultrasound effectiveness in reducing oil migration reduction. FIG. 5 shows a significant decrease in crystal size for PK73 but a decrease in oil migration is not observed as shown in FIG. 5.

### EXAMPLES

The following examples are illustrative only and are not intended to limit the disclosure in any way.

### Example 1

In one embodiment described herein, a sonicated low saturated lipid generated by the methods described herein is used in an exemplary chocolate composition. In one embodiment described herein, an exemplary chocolate composition comprising the high intensity ultrasound treated lipid having composition of Table 1 including all possible iterations of specified ranges, including or excluding the optional colorings, flavorings, or additional food additives and ingredients is provided.

TABLE 1
Exemplary Chocolate Composition

| Exemplary Components | Composition Range (%) |
|---|---|
| Chocolate liquor | 7-15 |
| Sugar | 15-35 |
| Milk powder | 4-10 |
| Sonicated low saturated lipid | 10-30 |
| Cocoa butter | 0-10 |
| Flavorings | 0.1-0.8 |

### Example 2

In one embodiment described herein, a sonicated low saturated lipid generated by the methods described herein is used in an exemplary confectionery product, following the protocol according to 21 C.F.R. § 163 which is incorporated by reference herein. The sonicated low saturated lipid replacing the cocoa butter either partially or completely. In some embodiments, high intensity ultrasound is applied after all the ingredients are mixed either before or after cooling. In some embodiments, sonication is applied before and/or after tempering.

### Example 3

In one embodiment described herein, a sonicated low saturated lipid generated by the methods described herein is used in a confectionery filling. The sonicated low saturated lipid is mixed with sugar or a sweetener. The sugar or sweetener content is in a range of 0% up to 90%. Optionally, flavors, colors or other food additives and ingredients may be added. In one embodiment, the fat-sugar/sweetener mixture is covered with chocolate or compound chocolate. In another embodiment, high intensity ultrasound is applied before and/or after mixing the fat with sugar/sweetener and before covering with chocolate or compound chocolate.

### Example 4

In one embodiment described herein, an exemplary frozen dessert composition comprising the high intensity ultrasound treated lipid having composition of Table 2 including all possible iterations of specified ranges that provide 100% for the total weight percentage, including or excluding the optional colorings, flavorings, artificial sweeteners, or food additives.

TABLE 2
Exemplary Frozen Dessert Composition

| Exemplary Components | Composition (%) |
|---|---|
| Sodium caseinate | 1-6.1 |
| Polysorbate 60 | 0-0.01 |
| Carrageenan | 0.01-0.03 |
| Sucrose | 0-11.5 |
| Sonicated low saturated lipid | 5-14 |
| water | 45-63.6 |
| Gelatin | 0-0.16 |
| Vanilla extract | 0-0.2 |
| Frozen egg yolks (10% sucrose) | 2-4.3 |
| Color, flavors | 0-0.1 |

### Example 5

In one embodiment described herein, a sonicated low saturated lipid generated by the methods described herein is used in an exemplary salad dressing composition having composition of Table 3, including all possible iterations of specified ranges that provide 100% for the total weight percentage, including or excluding the optional colorings, flavorings, or food additives or ingredients is provided.

TABLE 3
Exemplary Salad Dressing Composition

| Exemplary Components | Composition (%) |
|---|---|
| Water | 40-60.1 |
| Titanium dioxide | 0-0.1 |
| Sonicated low saturated lipid | 2-12.3 |
| Vinegar | 4-14 |
| Xanthan gum | 0-0.4 |
| Starch | 0-2.1 |
| Coloring | 0-0.5 |
| Corn Syrup | 2-6 |
| Seasonings | 0.2-2.89 |
| Ascorbic acid | 0-0.01 |
| Maltodextrin | 0-0.1 |
| Salt | 0.025-1.5 |

The exemplary frozen dessert product of this embodiment comprising sonicated low saturated fat provides a rich mouthfeel and cooling as that of an ice cream and maintains its body and structure without phase separation during storage and during serving the frozen dessert product.

### Example 6

In one embodiment described herein, a sonicated low saturated lipid generated by the methods described herein is used in an exemplary spread formulated with vegetable oil-based fats (non-dairy) or dairy-based fats. The spreads comprise about 15% to about 80% fat and about 20% to about 65% water, and about 0.1 to about 5% emulsifiers. Optionally, additional food additives, seasonings and ingredients may be included in the formulation. High intensity ultrasound is applied before, during, and/or after the emulsification process at power levels between about 3 watts and about 100 Watts for a duration between about 1 second and about 10 seconds.

### Example 7

In one embodiment described herein, a sonicated low saturated lipid generated by the methods described herein is used in an exemplary nut-based spread where the spreads are defined by 21 C.F.R. § 164, which is incorporated by reference herein. High intensity ultrasound is applied to the freshly made spread at power levels between about 3 watts and about 100 Watts for a duration between about 1 second and about 10 seconds.

### Example 8

In one embodiment described herein, an exemplary spread composition comprising the high intensity ultrasound treated lipid having composition of Table 4 including all possible iterations of specified ranges that provide 100% for the total weight percentage, including or excluding the optional colorings, flavorings, or food additives is provided.

TABLE 4
Exemplary Spread Composition

| Exemplary Components | Composition Range (%) |
|---|---|
| Water | 20-55 |
| Low saturated oil | 20-70 |
| (soybean oil, sunflower | |
| Hydrocolloid | 1-15 |
| Seasonings or flavor | 0.1-1 |
| Beta carotene | 0.05-1 |
| Potassium sorbate | 0.01-0.05 |
| Salt | 0.25-0.5 |

### Example 9

In one embodiment described herein, a sonicated low saturated lipid generated by the methods described herein is used in an exemplary margarine where the margarine is defined by 9 C.F.R. 319 (Subpart P), which is incorporated by reference herein. High intensity ultrasound is applied before, during, and/or after the emulsification process at power levels between about 3 watts and about 100 Watts for a duration between about 1 second and about 10 seconds.

### Example 10

In one embodiment described herein, a sonicated low saturated lipid generated by the methods described herein is used in an exemplary shortening used for baking and confectionery applications. High intensity ultrasound is applied during the shortening manufacture following common manufacture procedures known in the art using either batch, in a heat exchanger, or continuous systems, at power levels between about 3 watts and about 100 Watts for a duration between about 1 second and about 10 seconds.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method for reducing lipid migration of a lipid composition in a foodstuff, the method comprising sonicating a low saturated lipid with a high intensity ultrasound, wherein the low saturated lipid is selected from the group consisting of: one or more of mono-, di-, or tri-fatty acid esters of glycerol; and adding the sonicated low saturated lipid to a foodstuff.

2. The method of claim 1, wherein the low saturated lipid is in a lipid mixture where the low saturated lipid is from 20% to about 35% by weight of the lipid mixture.

3. The method of claim 1, wherein the low saturated lipid is selected from a palm oil, a soybean oil, a coconut oil, a vegetable oil, a cocoa butter, a cocoa lipid, an anhydrous milk fat, a lard, a tallow, and mixtures thereof.

4. The method of claim 1, wherein the high intensity ultrasound has a frequency of about 15 kHz to about 100 kHz.

5. The method of claim 1, wherein the high intensity ultrasound has a frequency of about 18 kHz to about 22 kHz.

6. The method of claim 1, wherein the duration of high intensity ultrasound is between about 1 second and about 10 seconds.

7. The method of claim 1, wherein the intensity of high intensity ultrasound is between about 3 Watts and about 100 Watts.

8. The method of claim 1, wherein the duration, intensity, and frequency of the ultrasound are configured so that the lipid does not exceed its melting point.

9. The method of claim 1, wherein the high intensity ultrasound is applied at the onset of crystallization.

10. The method of claim 1, wherein the high intensity ultrasound is applied before crystallization.

11. The method of claim 1, wherein high intensity ultrasound is applied to a lipid composition comprising the low saturated lipid which crystallizes under static conditions.

12. The method of claim 1, wherein high intensity ultrasound is applied to a lipid that crystallizes under agitated conditions, wherein the agitation is between about 5 rpm and about 200 rpm.
